(19) United States
(12) Patent Application Publication
(10) Pub. No.: US 2021/0336286 A1
(43) Pub. Date: Oct. 28, 2021

(54) FUEL CELL SYSTEM

(71) Applicant: TOYOTA JIDOSHA KABUSHIKI KAISHA, Toyota-shi (JP)

(72) Inventor: Masaaki MATSUSUE, Mishima-shi (JP)

(73) Assignee: TOYOTA JIDOSHA KABUSHIKI KAISHA, Toyota-shi (JP)

(21) Appl. No.: 17/191,244

(22) Filed: Mar. 3, 2021

(30) Foreign Application Priority Data
Apr. 27, 2020 (JP) 2020-078276

(51) Int. Cl. H01M 8/2483; H01M 8/241; H01M 8/247; H01M 8/04746; H01M 8/04089; H01M 8/04082; H01M 8/2457

(52) U.S. Cl. CPC H01M 8/2483; H01M 8/241; H01M 8/247; H01M 2250/20; H01M 8/04097; H01M 8/04201; H01M 8/2457; H01M 8/04753

(57) ABSTRACT

A fuel cell system includes a stack of unit cells generating power using reaction gasses, an end plate stacked on an end face of the stack, a circulation passage for fuel off-gas, and an ejector including an inflow port for fuel gas, a suction port sucking fuel off-gas in from the circulation passage, an ejection port ejecting fuel gas and fuel off-gas, and a diffuser diffusing fuel gas and fuel off-gas toward the ejection port, the stack including a manifold through which fuel gas and fuel off-gas flow, the end plate having a recess accommodating the ejector, and a continuous hole between the ejection port and the manifold, the ejector being in contact with an inner face of the recess such that a flow direction of fuel gas and fuel off-gas in the diffuser is along a plate surface of the end plate and the suction port is exposed.

### CROSS-REFERENCE TO RELATED APPLICATION

This application is based upon and claims the benefit of priority of the prior Japanese Patent Application No. 2020-078276, filed on Apr. 27, 2020, the entire contents of which are incorporated herein by reference.

### FIELD

The present disclosure relates to a fuel cell system.

### BACKGROUND

A fuel cell includes a plurality of unit cells generating electric power by a chemical reaction between fuel gas and oxidant gas, and a pair of end plates stacked on respective end faces of the stacked unit cells in the stack direction of the unit cells. For example, Japanese Patent Application Publication No. 2001-143734 (Patent Document 1) discloses a fuel cell system in which an ejector that circulates fuel off-gas to the fuel cell and a recirculation passage of the fuel off-gas from the fuel cell to the ejector are disposed inside one of the end plates.

### SUMMARY

The structure disclosed in Patent Document 1 can reduce the installation space for the fuel cell system. However, when the recirculation passage of the fuel off-gas is disposed inside the end plate, the end plate is heated by heat generation of the fuel cell. Therefore, the temperature of the fuel off-gas increases, and the volume of the fuel off-gas expands. This reduces the amount of the fuel gas in the fuel off-gas circulating from the ejector to the fuel cell, and thereby, the power generation performance may degrade.

Additionally, since the ejector is supplied with the low-temperature fuel gas from the fuel tank, the fuel off-gas in the ejector is cooled by the adiabatic expansion of the fuel gas. The fuel off-gas contains water vapor produced through the power generation of the fuel cell. Therefore, when the fuel off-gas is cooled, condensation occurs because of decrease in the amount of saturated vapor. Liquid water formed by condensation flows from the ejector into the passage of the fuel gas in the fuel cell and may prevent the flow of the fuel gas, resulting in degradation in the power generation performance.

Therefore, an object of the present disclosure is to provide a small-footprint fuel cell system capable of reducing degradation in power generation performance.

The above object is achieved by a fuel cell system including: a stack of a plurality of unit cells generating electric power by an electrochemical reaction between a fuel gas and an oxidant gas; a first end plate and a second end plate that are stacked on end faces of the stack in a stack direction of the plurality of unit cells, respectively; a circulation passage through which a fuel off-gas discharged from the stack circulates to the stack; and an ejector including an inflow port, a suction port, an ejection port, and a diffuser, the fuel gas stored in a tank flowing into the inflow port, the fuel off-gas being sucked in the suction port from the circulation passage, the ejection port ejecting the fuel gas and the fuel off-gas, the fuel gas and the fuel off-gas flowing toward the ejection port through the diffuser, wherein the stack includes a manifold through which the fuel gas and the fuel off-gas flow along the stack direction, wherein the first end plate has a recess portion that accommodates the ejector, and a continuous hole that enables communication between the ejection port and the manifold, wherein the ejector is in contact with an inner face of the recess portion in a manner such that a direction in which the fuel gas and the fuel off-gas in the diffuser flows is along a plate surface of the first end plate and the suction port is exposed.

In the above structure, the ejector is in contact with the inner face of the recess portion in a manner such that the flow direction of the fuel gas and the fuel off-gas in the diffuser is along the plate surface of the end plate and the suction port is exposed. This structure allows the ejector to sufficiently receive, from the end plate, the heat generated through the power generation of the fuel cell stack. Therefore, the ejector can increase the temperature of the low-temperature fuel gas that has flown into the ejector from the tank, and inhibit the fuel off-gas from being cooled. Thus, condensation is effectively inhibited.

In addition, since the suction port of the ejector is exposed from the recess portion, the circulation passage is not accommodated in the recess portion. Therefore, the fuel off-gas flowing through the circulation passage is inhibited from increasing in temperature, and the decrease in the amount of the fuel gas in the fuel off-gas circulating to the fuel cell stack is inhibited.

Therefore, the fuel cell system can reduce the degradation in power generation performance and reduce the footprint.

The above fuel cell system may include an introduction line that is accommodated in the recess portion and introduces the fuel gas and the fuel off-gas ejected from the ejection port into the continuous hole, and the introduction line may change a direction in which the fuel gas and the fuel off-gas are ejected from the ejector, to the stack direction.

In the above fuel cell system, the first end plate may include an inflow passage extending from the inflow port to a side face of the first end plate along the plate surface, and the inflow port may be connected to the tank through the inflow passage.

The above fuel cell system may include a flow member having an opening that is along a plate surface of the first end plate, the flow member intaking, from the opening, the fuel gas discharged from the tank, and causing the fuel gas to flow into the inflow port.

### Advantageous Effects

According to the present disclosure, it is possible to provide a small-footprint fuel cell system capable of reducing degradation in its power generation performance.

### BRIEF DESCRIPTION OF THE DRAWINGS

FIG. 1 is an exploded perspective view illustrating an exemplary unit cell of a fuel cell;

FIG. 2 is a configuration diagram of an exemplary fuel cell system;

FIG. 3 is a perspective view illustrating an exemplary structure of an ejector;

FIG. 4 illustrates an exemplary manner of accommodating the ejector in a recess portion of an end plate; and

FIG. 5 illustrates another exemplary manner of accommodating the ejector in the recess portion of the end plate.

### DETAILED DESCRIPTION

[Structure of a Unit Cell 2]

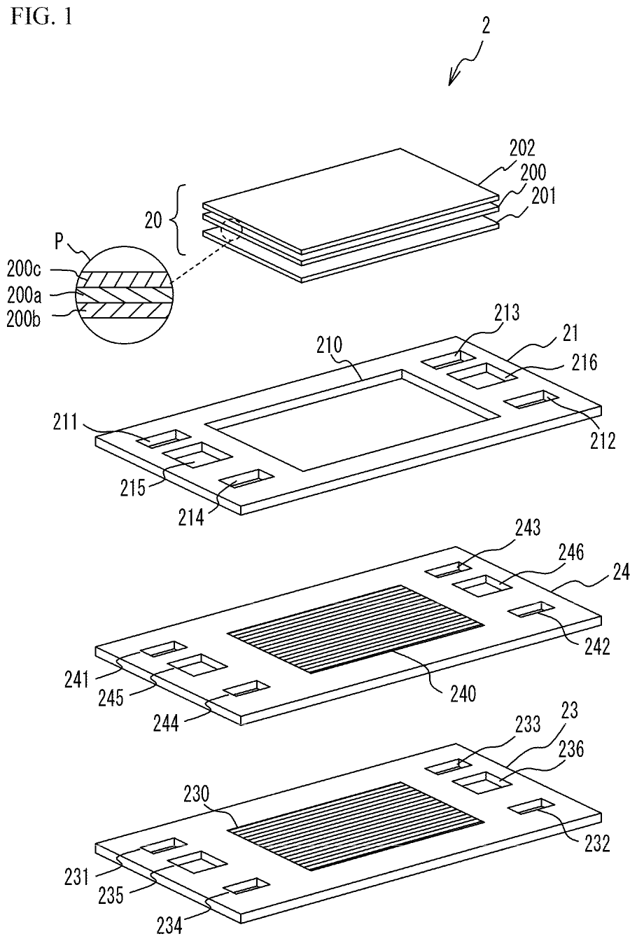

FIG. 1 is an exploded perspective view illustrating an exemplary unit cell 2 of a fuel cell. The fuel cell is used in, for example, a fuel cell vehicle, but the applications of the fuel cell are not particularly limited. The fuel cell is a polymer electrolyte fuel cell, and includes a stack having a plurality of the unit cells 2 stacked.

The unit cell 2 is supplied with a fuel gas (e.g., hydrogen) and an oxidant gas (e.g., air), and generates electric power by an electrochemical reaction between the fuel gas and the oxidant gas. The fuel gas and the oxidant gas are examples of reaction gases.

The unit cell 2 includes a MEGA 20, a frame 21, a cathode separator 23, and an anode separator 24 that are arranged along the direction in which the unit cells 2 are stacked (the stack direction of the unit cells 2). The cathode separator 23 and the anode separator 24 are an example of a pair of separators.

The MEGA 20 includes a membrane electrode assembly (MEA) 200, and a pair of gas diffusion layers (GDLs) 201 and 202 sandwiching the MEA 200 therebetween. The reference letter P indicates the multilayer structure of the MEA 200. The MEA 200 includes an electrolyte membrane 200a, and an anode electrode catalyst layer 200b and a cathode electrode catalyst layer 200c sandwiching the electrolyte membrane 200a therebetween.

The electrolyte membrane 200a includes an ion exchange resin film exhibiting good protonic conductivity in a wet condition, for example. Examples of such an ion exchange resin film include, but are not limited to, a fluorine resin-based film having a sulfonate group as an ion-exchange group, such as Nafion (registered trademark).

Each of the anode electrode catalyst layer 200b and the cathode electrode catalyst layer 200c is formed as a porous layer containing catalyst carrying conductive particles and proton conductive electrolytes and having gas diffusivity. For example, the anode electrode catalyst layer 200b and the cathode electrode catalyst layer 200c are formed as dry paint films of catalyst ink that is a dispersion solution containing platinum carrying carbon and proton conductive electrolytes.

The fuel gas is supplied to the anode electrode catalyst layer 200b through the gas diffusion layer 201, and the oxidant gas is supplied to the cathode electrode catalyst layer 200c through the gas diffusion layer 202. The gas diffusion layers 201 and 202 are formed by stacking a water-shedding microporous layer on a base material such as, but not limited to, carbon paper. The microporous layer contains water-shedding resin such as polytetrafluoroethylene (PTFE), a conductive material such as carbon black, and the like. The MEA 200 generates electric power by an electrochemical reaction using the oxidant gas and the fuel gas.

The frame 21 is constructed of, for example, a resin sheet having a rectangular outer shape. Examples of the material of the frame 21 include polyethylene terephthalate (PET)-based resin, syndiotactic polystyrene (SPS)-based resin, and polypropylene (PP)-based resin. The frame 21 has a frame shape, and has a rectangular opening 210 in the center part thereof.

The opening 210 is located in the position corresponding to that of the MEGA 20, and the outer peripheral end of the MEA 200 is bonded to the edge of the opening 210 through an adhesion layer. Therefore, the MEA 200 is held by the frame 21.

Through-holes 211 to 216 penetrating through the frame 21 in the thickness direction of the frame 21 are formed in the end portions of the frame 21. The through-holes 211, 215, and 214 are formed in one of the end portions of the frame 21, and the through-holes 213, 216, and 212 are formed in the other of the end portions of the frame 21. The through-holes 211 to 216 overlap with through-holes 231 to 236 of the cathode separator 23 and through-holes 241 to 246 of the anode separator 24, respectively.

The through-holes 211, 241, and 231 are part of an anode side inlet manifold that is a supply port of the fuel gas, and the fuel gas flows through the through-holes 211, 241, and 231 along the stack direction of the unit cells 2. The through-holes 212, 242, and 232 are part of an anode side outlet manifold that is a discharge port of the fuel gas, and the fuel off-gas flows through the through-holes 212, 242, and 232 along the stack direction of the unit cells 2.

The through-holes 213, 243 and 233 are part of a cathode side inlet manifold that is a supply port of the oxidant gas, and the oxidant gas flows through the through-holes 213, 243 and 233 along the stack direction of the unit cells 2. The through-holes 214, 244, and 234 are part of a cathode side outlet manifold that is a discharge port of the oxidant gas, and the oxidant off-gas flows through the through-holes 214, 244, and 234 along the stack direction of the unit cells 2.

The through-holes 215, 245, and 235 are part of a cooling water inlet manifold that is a supply port of cooling water that cools the unit cell 2, and the cooling water flows through the through-holes 215, 245, and 235 along the stack direction of the unit cells 2. The through-holes 216, 246, and 236 are part of a cooling water outlet manifold that is a discharge port of the cooling water, and the cooling water flows through the through-holes 216, 246, and 236 in the stack direction of the unit cells 2.

Each of the cathode separator 23 and the anode separator 24 is made of a metal such as SUS, or titanium, is formed into a sheet, and has a rectangular outer shape. The cathode separator 23 and the anode separator 24 are bonded to each other using, for example, laser welding with the plate surfaces of the cathode separator 23 and the anode separator 24 opposed to each other. The anode separator 24 is arranged at the anode side of the MEGA 20, while the cathode separator 23 is arranged at the cathode side of the MEGA 20 of another unit cell 2 adjacent to the unit cell 2.

The anode separator 24 is bonded to the frame 21 by an adhesive agent. Therefore, the frame 21 is fixed to the anode separator 24.

The anode separator 24 has the through-holes 241 to 246 penetrating through the anode separator 24 in the thickness direction of the anode separator 24, and an anode passage portion 240 having a wave-plate shape. The through-holes 241, 245, and 244 are formed in one of the end portions of the anode separator 24, and the through-holes 243, 246, and 242 are formed in the other of the end portions of the anode separator 24.

Groove-shaped fuel gas passages, through which the fuel gas flows, are formed on a first surface, which is closer to the MEGA 20, of the anode passage portion 240. The fuel gas passages are opposite to the gas diffusion layer 201, and the fuel gas is supplied from the fuel gas passages to the gas diffusion layer 201. In addition, groove-shaped cooling water passages, through which cooling water flows, are formed on a second surface, which is closer to the cathode separator 23, of the anode passage portion 240.

The anode passage portion 240 is formed by, for example, bending using a press die. The fuel gas passages and the cooling water passages may be formed in a straight-line shape or may be formed in a meander shape.

The cathode separator 23 has the through-holes 231 to 236 penetrating through the cathode separator 23 in the thickness direction of the cathode separator 23, and a cathode passage portion 230 having a wave-plate shape. The through-holes 231, 235, and 234 are formed in one of the end portions of the cathode separator 23, while the through-holes 233, 236, and 232 are Ruined in the other of the end portions of the cathode separator 23.

Groove-shaped cooling water passages, through which a cooling medium flows, are formed on a first surface, which is closer to the anode separator 24, of the cathode passage portion 230. In addition, groove-shaped oxidant gas passages, through which oxidant gas flows, are formed on a second surface, which is closer to the MEGA 20 of another unit cell 2 adjacent to the unit cell 2, of the cathode passage portion 230. The oxidant gas passages are opposite to the gas diffusion layer 202 of the MEGA 20 of the adjacent unit cell 2, and the oxidant gas is supplied from the oxidant gas passages to the diffusion layer 202.

The cathode passage portion 230 is formed by, for example, bending using a press die. The cooling medium passages and the fuel gas passages may be formed in, for example, a straight-line shape, or may be formed in a meander shape. The materials of the cathode separator 23 and the anode separator 24 are not limited to a metal, and may be formed of a carbon molded article.

[Configuration of a Fuel Cell System 9]

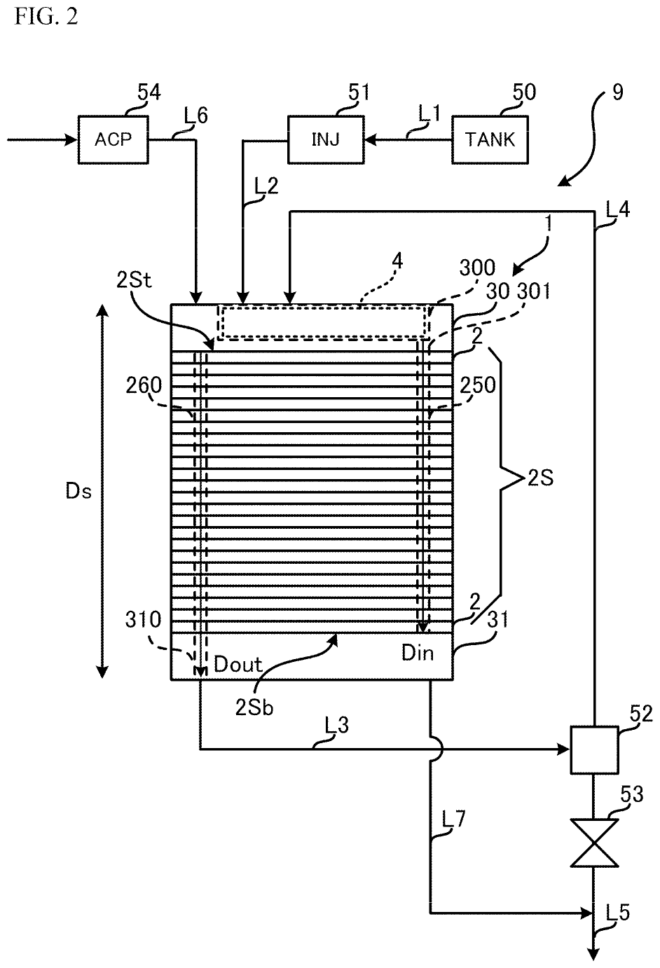

FIG. 2 is a configuration diagram of an exemplary fuel cell system 9. The fuel cell system 9 is installed in, for example, a fuel cell vehicle, which is not illustrated, and is used as a power source of the motor of the fuel cell vehicle.

The fuel cell system 9 includes a fuel cell stack 1, an ejector 4, a tank 50, an injector (INJ) 51, a gas-liquid separator 52, a discharge valve 53, and an air compressor (ACP) 54. In addition, the fuel cell system 9 includes a fuel line L1, a fuel supply line L2, a fuel discharge line L3, a fuel recirculation line L4, a discharge and drain line L5, an air supply line L6, and an air discharge line L7.

The fuel cell stack 1 includes a stack 2S having a plurality of the unit cells 2 stacked, and a pair of end plates 30 and 31 stacked on respective end faces 2St and 2Sb in the stack direction Ds of the stack 2S. Each of the end plates 30 and 31 is a metal plate having a substantially rectangular parallelepiped shape and formed of, for example, SUS. The end plate 30 is an example of a first end plate, while the end plate 31 is an example of a second end plate.

The stack 2S includes an anode side inlet manifold 250 through which the fuel gas to be supplied to each unit cell 2 flows, and an anode side outlet manifold 260 through which the fuel gas discharged from each unit cell 2 (i.e., the fuel off-gas) flows. Although illustration is omitted, the stack 2S also includes a cathode side inlet manifold through which the oxidant gas to be supplied to each unit cell 2 flows, and a cathode side outlet manifold through which the oxidant gas discharged from each unit cell 2 (i.e., the oxidant off-gas) flows.

The fuel cell stack 1 supplies electric power generated by an electrochemical reaction between the fuel gas and the oxidant gas to the motor and the like.

The air compressor 54 intakes air from, for example, the outside of the fuel cell vehicle as the oxidant gas, and compresses the oxidant gas. The air compressor 54 pumps the oxidant gas to the cathode side inlet manifold of the fuel cell stack 1 through the air supply line L6. The oxidant gas is distributed to each unit cell 2 from the cathode side inlet manifold, and is then used for the power generation.

The tank 50 stores, for example, compressed hydrogen gas as the fuel gas. The fuel gas flows from the tank 50 into the injector 51 through the fuel line L1. The injector 51 injects the fuel gas according to the electric power that the fuel cell stack 1 is requested to generate. The fuel gas flows from the injector 51 into the ejector 4 through the fuel supply line L2.

The ejector 4 mixes the fuel gas from the injector 51 with the fuel off-gas discharged from the fuel cell stack 1, and ejects the mixed gas to the anode side inlet manifold 250 of the stack 2S. The ejector 4 is accommodated in a recess portion 300 formed on the plate surface of the end plate 30. The recess portion 300 is a hole of which the length direction is parallel to the side of the rectangular end plate 30. The ejector 4 is in contact with the inner face of the recess portion 300.

Therefore, the ejector 4 receives the heat generated through the power generation of the fuel cell stack 1, and increases in temperature. This allows the ejector 4 to heat up the low-temperature fuel gas from the tank 50.

The fuel gas ejected from the ejector 4 passes through a continuous hole 301 formed on the bottom of the recess portion 300, flows through the anode side inlet manifold 250 (see an arrow Din), is distributed from the anode side inlet manifold 250 to each unit cell 2, and is then used for the power generation. The anode side inlet manifold 250 is an example of a manifold through which the fuel gas and the fuel off-gas flow along the stack direction Ds.

The fuel off-gas flows from each unit cell 2 into the anode side outlet manifold 260. The fuel off-gas flows through a discharge hole 310 of the end plate 31 from the anode side outlet manifold 260, and is discharged to the fuel discharge line L3 (see the arrow Dout). The discharge hole 310 is formed in the thickness direction of the end plate 31.

The gas-liquid separator 52 is connected to the fuel discharge line L3, the fuel recirculation line L4, and the discharge and drain line L5. The gas-liquid separator 52 separates liquid water from the fuel off-gas flowing from the fuel discharge line L3 into the gas-liquid separator 52, and stores the liquid water in the bottom thereof. The discharge valve 53 is connected to the discharge and drain line L5. When the discharge valve 53 is opened, the liquid water stored in the gas-liquid separator 52 flows through the discharge and drain line L5, and is discharged to the outside.

The discharge and drain line L5 is connected to the air discharge line L7 at the downstream side of the discharge valve 53. The air discharge line L7 is connected to the cathode side outlet manifold through which the oxidant off-gas discharged from each unit cell 2 flows. The oxidant off-gas flows from the cathode side outlet manifold into the air discharge line L7, and is discharged from the discharge and drain line L5 to the outside.

The fuel off-gas flows from the gas-liquid separator 52 into the ejector 4 through the fuel recirculation line L4. The ejector 4 mixes the fuel gas supplied from the tank 50 with the fuel off-gas, and ejects the mixed gas to the anode side inlet manifold 250 through the continuous hole 301. As a result, the fuel off-gas circulates to the fuel cell stack 1. The fuel recirculation line L4 is an example of a circulation passage through which the fuel off-gas discharged from the stack 2S circulates to the stack 2S.

[Structure of the Ejector 4]

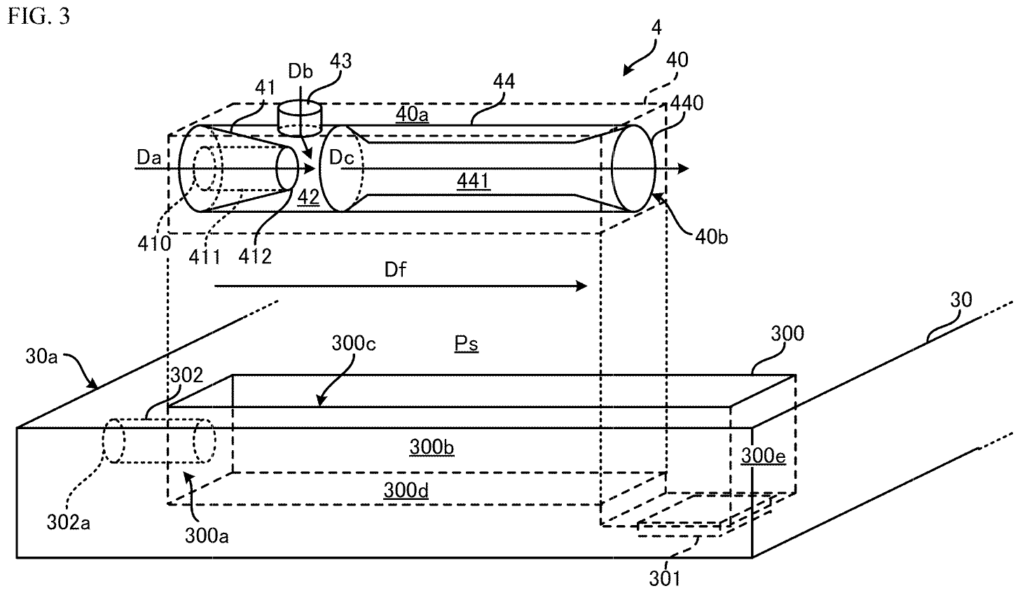

FIG. 3 is a perspective view illustrating an exemplary structure of the ejector 4. FIG. 3 illustrates not only the ejector 4 but also the end plate 30 having the recess portion 300 that accommodates the ejector 4.

The ejector 4 has, as an example, a substantially cylindrical gas passage thereinside, and is encased in a case 40 (see dashed lines) having a substantially rectangular parallelepiped shape. The material of the case 40 is preferably a material having high thermal conductivity. The recess portion 300 is formed as a space having a substantially rectangular parallelepiped shape so as to correspond to the outer shape of the case 40. The ejector 4 is not necessarily encased in the case 40, and may be accommodated directly in the recess portion 300.

The ejector 4 includes a substantially cone-shaped nozzle 41, a mixing chamber 42, a substantially cylindrical suction port 43, and a diffuser 44. The nozzle 41 includes an inlet 410 of the fuel gas, a passage 411, and an outlet 412. The inlet 410 of the nozzle 41 is connected to an inflow passage 302 linearly extending from an inner face 300a of one end of the recess portion 300 to a side face 30a of the end plate 30. The shape of the inflow passage 302 is not limited to a straight-line shape, and may be a curved line shape.

An inlet 302a of the inflow passage 302 opens to the side face 30a, and is connected to the outlet of the fuel supply line L2. That is, the inlet 410 of the nozzle 41 is connected to the tank 50 through the inflow passage 302. The fuel gas passes through the inflow passage 302 from the fuel supply line L2, flows from the inlet 410 of the nozzle 41 into the passage 411, and is then injected from the outlet 412 to the mixing chamber 42, as indicated by the arrow Da. Thus, the ejector 4 can intake the fuel gas from the side face 30a of the end plate 30. The inlet 410 of the nozzle 41 is an example of an inflow port into which the fuel gas stored in the tank 50 flows.

The suction port 43 communicated with the mixing chamber 42 is disposed on the outer face of the case 40. The suction port 43 is not in contact with the inner face of the recess portion 300, and is exposed from the recess portion 300. The suction port 43 is connected to the outlet of the fuel recirculation line L4. After flowing through the fuel recirculation line L4, the fuel off-gas is sucked in from the suction port 43, and then flows into the mixing chamber 42 as indicated by the arrow Db.

The fuel gas from the nozzle 41 and the fuel off-gas from the suction port 43 are mixed in the mixing chamber 42. The mixture of the fuel gas and the fuel off-gas flows through an ejection passage 441 in the diffuser 44, and is then ejected from an ejection port 440 as indicated by the reference letter Dc. The direction in which the ejection passage 441 extends is the longitudinal direction of the ejector 4. The fuel gas and the fuel off-gas ejected from the ejection port 440 flows from the continuous hole 301 into the anode side inlet manifold 250 through a fuel introduction line described later.

When the ejector 4 is accommodated in the recess portion 300, at least a part of each of the faces other than a face 40a on which the suction port 43 is disposed and a face 40b on which the ejection port 440 is disposed among faces of the case 40 having a substantially rectangular parallelepiped shape is in contact with the corresponding one of inner faces 300a to 300d of the recess portion 300. Here, the inner face 300d is the bottom face of the recess portion 300, and the inner faces 300b and 300c are a pair of side faces of the recess portion 300. The inner face 300e is the end face opposite to the inner face 300a on which the inflow passage 302 is disposed. Since the inner face 300e is located at a fuel introduction line 6 side, the inner face 300e is not in contact with the ejector 4.

The ejector 4 is accommodated in the recess portion 300 in a manner such that the direction Df in which the fuel gas and the fuel off-gas in the diffuser 44 flow (hereinafter, described as a “flow direction Df”) is along the plate surface Ps of the end plate 30.

[Exemplary Manner of Accommodating the Ejector 4]

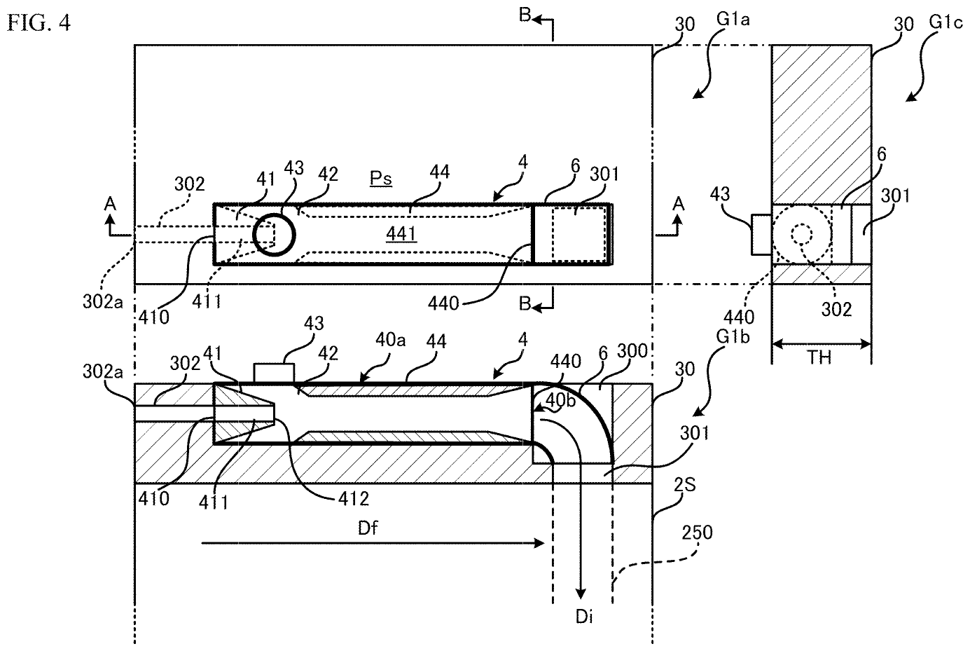

FIG. 4 illustrates an exemplary manner of accommodating the ejector 4 in the recess portion 300 of the end plate 30. In FIG. 4, the same reference numerals are attached to the components common to those in FIG. 3, and the description thereof is omitted.

The reference letter G1a indicates a plan view when the plate surface Ps of the end plate 30 is viewed from the front. The reference letter G1b indicates a cross-sectional view taken along line A-A in the plan view indicated by the reference letter G1a. The reference letter G1c indicates a cross-sectional view taken along line B-B in the plan view indicated by the reference letter G1a.

The recess portion 300 accommodates the ejector 4 and the fuel introduction line 6. The fuel introduction line 6 is accommodated adjacent to the face 40b of the ejector 4. The fuel introduction line 6 is an example of an introduction line, and introduces the fuel gas and the fuel off-gas ejected from the ejection port 440 of the ejector 4 into the continuous hole 301. The inlet of the fuel introduction line 6 is connected to the ejection port 440, and the outlet of the fuel introduction line 6 is connected to the continuous hole 301.

Thus, the fuel introduction line 6 bends in a manner such that the orientation of the inlet is substantially perpendicular to the orientation of the outlet. This structure allows the fuel introduction line 6 to change the direction in which the fuel gas and the fuel off-gas are ejected from the ejector 4, to the stack direction Ds.

Therefore, even when the flow direction Df in the ejector 4 is substantially perpendicular to the stack direction Ds of the stack 2S as in the present embodiment, the fuel gas and the fuel off-gas can be introduced from the ejector 4 to the anode side inlet manifold 250 as indicated by the arrow Di. Instead of the fuel introduction line 6, a passage similar to the fuel introduction line 6 may be disposed inside the end plate 30.

The ejector 4 is in contact with the inner face of the recess portion 300 in a manner such that the flow direction Df of the fuel gas and the fuel off-gas in the diffuser 44 is along the plate surface Ps of the end plate 30 and the suction port 43 is exposed. This structure allows the ejector 4 to sufficiently receive the heat generated through the power generation of the fuel cell stack 1 from the end plate 30. Therefore, the ejector 4 can increase the temperature of the low-temperature fuel gas flowing from the tank 50 into the ejector 4, and inhibit the fuel off-gas from being cooled. Thus, condensation is effectively inhibited.

By contrast, when the ejector 4 is accommodated in the recess portion 300 in a manner such that the flow direction Df intersects with the plate surface Ps of the end plate 30 at right angles, i.e., the flow direction Df is substantially parallel to the stack direction Ds of the stack 2S as in the Patent Document 1, the length in the longitudinal direction of the ejector 4, i.e., the length in the flow direction Df, which is the direction in which the ejection passage 441 extends, of the ejector 4 is limited by the thickness TH of the end plate 30. In this case, it is impossible for the ejector 4 to receive sufficient heat from the end plate 30. Therefore, condensation is not effectively inhibited.

In addition, in the above case, when the thickness TH of the end plate 30 is increased, the limitation of the length in the longitudinal direction of the ejector 4 is reduced. However, as the thickness TH of the end plate 30 increases, the size of the fuel cell stack 1 increases, and a larger installation space becomes needed.

In addition, in the present embodiment, since the suction port 43 of the ejector 4 is exposed from the recess portion 300, the fuel recirculation line L4 is not accommodated in the recess portion 300. Thus, the fuel off-gas flowing through the fuel recirculation line L4 is inhibited from increasing in temperature, and the reduction in the amount of the fuel gas in the fuel off-gas circulating to the fuel cell stack 1 is inhibited.

Therefore, the fuel cell system 9 inhibits the degradation in power generation performance of the fuel cell stack 1, and reduces its footprint.

[Another Exemplary Manner of Accommodating the Ejector 4]

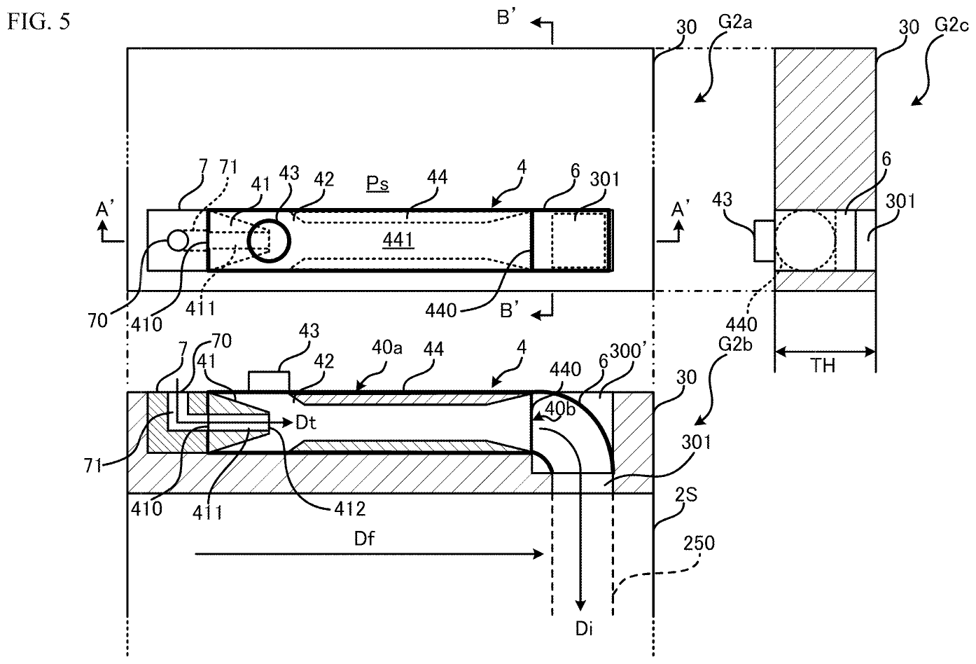

FIG. 5 illustrates another exemplary manner of accommodating the ejector 4 in a recess portion 300′ of the end plate 30. In FIG. 5, the same reference numerals are attached to the components common to those in FIG. 3 and FIG. 4, and the description thereof is omitted.

The reference letter G2a indicates a plan view when the plate surface Ps of the end plate 3 is viewed from the front. The reference letter G2b indicates a cross-sectional view taken along line A′-A′ in the plan view indicated by the reference letter G2a. The reference letter G1c indicates a cross-sectional view taken along line B′-B′ in the plan view indicated by the reference letter G2a.

The recess portion 300′ of this example accommodates a flow member 7 in addition to the ejector 4 and the fuel introduction line 6. Thus, the length in the longitudinal direction of the recess portion 300′ is longer than that of the recess portion 300. The flow member 7 has a substantially rectangular parallelepiped shape, and is adjacent to the opposite end of the ejector 4 from the fuel introduction line 6.

The flow member 7 has an opening 70 that is along the plate surface Ps of the end plate 30 and a passage 71 that bends at a substantially right angle from the opening 70 to the inlet 410 of the nozzle 41. The opening 70 has a circular shape, as an example, and is connected to the fuel supply line L2. The outlet of the passage 71 is connected to the inlet 410 of the nozzle 41. Thus, the fuel gas from the tank 50 flows from the opening 70 into the passage 71, and then flows through the passage 71 into the inlet 410 of the nozzle 41 as indicated by the arrow Dt.

Therefore, the ejector 4 can intake the fuel gas from the plate surface Ps side even when the inlet 410 of the nozzle 41 is not along the plate surface Ps of the end plate 30.

Although some embodiments of the present invention have been described in detail, the present invention is not limited to the specific embodiments but may be varied or changed within the scope of the present invention as claimed.

What is claimed is:

1. A fuel cell system comprising:
a stack of a plurality of unit cells generating electric power by an electrochemical reaction between a fuel gas and an oxidant gas;
a first end plate and a second end plate that are stacked on end faces of the stack in a stack direction of the plurality of unit cells, respectively;
a circulation passage through which a fuel off-gas discharged from the stack circulates to the stack; and
an ejector including an inflow port, a suction port, an ejection port, and a diffuser, the fuel gas stored in a tank flowing into the inflow port, the fuel off-gas being sucked in the suction port from the circulation passage, the ejection port ejecting the fuel gas and the fuel off-gas, the fuel gas and the fuel off-gas flowing toward the ejection port through the diffuser,
wherein the stack includes a manifold through which the fuel gas and the fuel off-gas flow along the stack direction,
wherein the first end plate has a recess portion that accommodates the ejector, and a continuous hole that enables communication between the ejection port and the manifold,
wherein the ejector is in contact with an inner face of the recess portion in a manner such that a direction in which the fuel gas and the fuel off-gas in the diffuser flows is along a plate surface of the first end plate and the suction port is exposed.

2. The fuel cell system according to claim 1, further comprising an introduction line that is accommodated in the recess portion and introduces the fuel gas and the fuel off-gas ejected from the ejection port into the continuous hole,
wherein the introduction line changes a direction in which the fuel gas and the fuel off-gas are ejected from the ejector, to the stack direction.

3. The fuel cell system according to claim 1,
wherein the first end plate includes an inflow passage extending from the inflow port to a side face of the first end plate along the plate surface,
wherein the inflow port is connected to the tank through the inflow passage.

4. The fuel cell system according to claim 1, further comprising a flow member having an opening that is along a plate surface of the first end plate, the flow member intaking, from the opening, the fuel gas discharged from the tank, and causing the fuel gas to flow into the inflow port.
